(19) United States
(12) Patent Application Publication
(10) Pub. No.: US 2007/0162857 A1
(43) Pub. Date: Jul. 12, 2007

(54) Automated multimedia authoring

(76) Inventors: Ralf Weber, Santa Clara, CA (US); Thomas Matthieu Alsina, Paris (FR); Adrian Diaconu, Palo Alto, CA (US); Timothy Martin, Sunnyvale, CA (US); Matt Evans, San Francisco, CA (US)

Correspondence Address: FISH & RICHARDSON P.C., PO BOX 1022, MINNEAPOLIS, MN, 55440-1022, US

(21) Appl. No.: 11/327,280

(22) Filed: Jan. 6, 2006

(51) Int. Cl. G06F 17/00

(52) U.S. Cl. 715/731; 715/825; 715/765

(57) ABSTRACT

Methods and computer program products related to multimedia applications are provided. In one implementation, a computer program product, encoded on a computer-readable medium is provided. The computer program product is operable to cause a data processing apparatus to perform operations including generating a user interface for receiving user input. The user interface includes a media content selection menu for selecting media content for a multimedia project and one or more regions for ordering selected media content for the multimedia project. The computer program product further includes automatically creating one or more menu screens according to the selected media content.

### CROSS-REFERENCE TO RELATED APPLICATIONS

This application is a related U.S. application Ser. Nos. 10/337,924 filed on Jan. 6, 2003, and 10/742,957 filed on Dec. 22, 2003, which are hereby incorporated by reference in their entirety.

### BACKGROUND

The present disclosure relates to multimedia applications.

The proliferation of various forms of digital media (e.g., still images, audio, video, etc.) has created a continuing need for improved multimedia authoring tools. Consumers typically use media authoring tools to compose, edit, and arrange digital media (e.g., video and audio content, still images, slideshows etc.) as part of a media project. Consumers render the finished media project into a file, which can be burned onto a Digital Versatile Disc (“DVD”) or other media, which can be played on a variety of devices.

Conventional multimedia authoring tools allow a user to generate professional quality media projects. In addition to providing content, the authoring tools typically enable users to create menu and submenu screens for enabling viewers to navigate content stored on the DVD using, for example, a television remote control or a mouse. For example, a typical DVD includes a hierarchy of menus allowing the viewer to select a movie to play or to access other features or content on the DVD, such as a chapter index for jumping to a particular chapter in the movie.

### SUMMARY

In general, in one aspect, a computer program product, encoded on a computer-readable medium is provided. The computer program product is operable to cause a data processing apparatus to perform operations including generating a user interface for receiving user input. The user interface includes a media content selection menu for selecting media content for a multimedia project and one or more regions for ordering selected media content for the multimedia project. The computer program product further includes automatically creating one or more menu screens according to the selected media content.

Implementations of the method can include one or more of the following features. The computer program product can further include receiving user input selecting media content from the media selection menu and receiving user input positioning the selected media content in a region of the one or more regions. Receiving user input selecting media content can include receiving a selection of movie content or receiving a selection of one or more still images. Automatically creating one or more menus screens can further include using the selected media content to define a menu screen hierarchy corresponding to the selected media content. Automatically creating one or more menu screens can also further include populating a menu screen with the selected media content. The user interface can further include a theme selection menu configured to receive user input selecting a theme for the one or more automatically created menu screens.

In general, in one aspect, a computer-implemented method is provided. The method includes receiving a first user input selecting media content to be included in a media project. The method also includes automatically creating one or more menu screens for navigating the selected media content in the media project, wherein a number and content of the one or more menu screens are defined according to the user selected media content.

Implementations of the method can include one or more of the following features. The method can further include receiving a second user input selecting a theme for the media project, where the theme defines a template structure for the one or more menu screens. The method can further include receiving a third user input defining a title for the media project. Receiving the first user input selecting media content can further include receiving a selection of one or more movies for inclusion in the media project or receiving a selection of one or more slideshows for inclusion in the media project.

Automatically creating one or more menu screens can further include creating a main menu screen including selection buttons for different types of media content selected by the user, creating one or more submenu screens according to the types of media content selected by the user, or extracting content from the selected content to provide representations of the particular content in the menu screens. The extracted content can be an image from a slideshow or a frame or clip from a movie. The extracted content can be randomly selected from the user selected media content.

In general, in another aspect, computer program product, encoded on a computer-readable medium is provided. The computer program product is operable to cause data processing apparatus to perform operations including receiving a first user input selecting media content to be included in a media project. The computer program product is also operable to automatically creating one or more menu screens for navigating the selected media content in the media project, a number and content of the one or more menu screens defined according to the user selected media content.

The disclosed implementations provide one or more of the following advantages. Menu screens can be automatically created for a media project. The user can select a theme for the automatically created menu screens to provide a consistent look and feel for the menu screens. For example, the menu screens may have a consistent color scheme, text font and contain images and video clips of objects associated with the theme. For each theme templates are provided for quickly generating menu screens with a minimal amount of user input. A user can also identify media content to be included in the menu screens. In some implementations, a user interface is provided to allow quick identification of media content to be included in a media project.

Media project authoring is simplified because the user does not need to lay out menu content and structure manually. A finished media project (e.g., a DVD) can be created including theme-based menus that can be used by a user to navigate media content stored on the DVD. The user can use the automatically generated menu screens as a starting point for user customization, saving authoring time. For example, the user can take the automatically generated menu screens for the media project and provide further edits and customization without having to build the menu screens from scratch.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a block diagram of an automated media-authoring tool.

FIG. 2 shows a process for creating a media project.

FIG. 3 shows a screenshot of a user interface for creating the media project.

FIG. 4 shows a screenshot of the user interface for creating a media project with one movie selected.

FIG. 5 shows a screenshot of the user interface for creating a media project with several movies selected.

FIG. 6 shows a screenshot of the user interface for creating a media project with one slideshow selected.

FIG. 7 shows a screenshot of the user interface for creating a media project including user selected content.

FIG. 8 shows a process for automatically creating the media project.

FIG. 9 shows a screenshot of a hierarchy of automatically created menu screens.

FIG. 10 shows a screenshot of an example of an automatically created menu screen of the media project.

FIG. 11 shows a screenshot of an example of an automatically created movies submenu screen of the media project.

FIG. 12 shows a screenshot of an example of an automatically created slideshow submenu screen of the media project.

FIG. 13 shows a screenshot of an example of an automatically created chapter index menu screen of a movie.

FIG. 14 shows a block diagram of a computer system for hosting an automated media authoring tool.

Like reference numbers and designations in the various drawings indicate like elements.

### DETAILED DESCRIPTION

Implementations of an automated media-authoring tool are disclosed for automatically generating menu screens for navigating content in a media project. The menu screens provide a visual environment for accessing media content. For example, a user creating a DVD using the automated media-authoring tool can select particular media content to be included in the DVD including movies, slideshows, and audio content. The user can also identify an overall theme for the menu screens (e.g., birthdays, travel, holidays, weddings, etc.). The automated media authoring tool can then automatically generate one or more menu screens to provide navigable menu screens for accessing content without further user input. In some implementations, the automated media-authoring tool can format and organize the created menu screens, including automatically populating the menu screens with user-selected content.

### Architecture

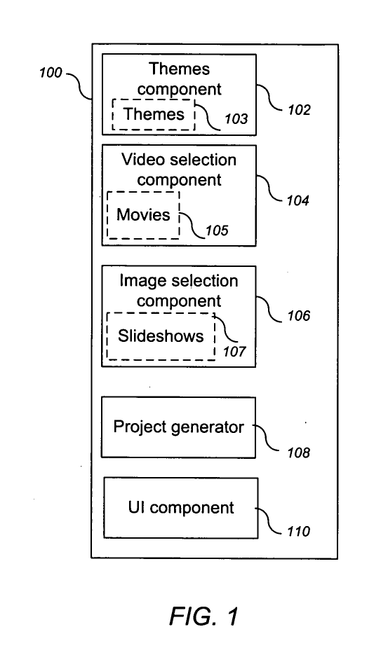

FIG. 1 is a block diagram of a software architecture for an automated media authoring tool. The automated media authoring tool 100 generally includes a themes component 102, a video selection component 104, an image selection component 106, a project generator 108, and a user interface (“UI”) component 110.

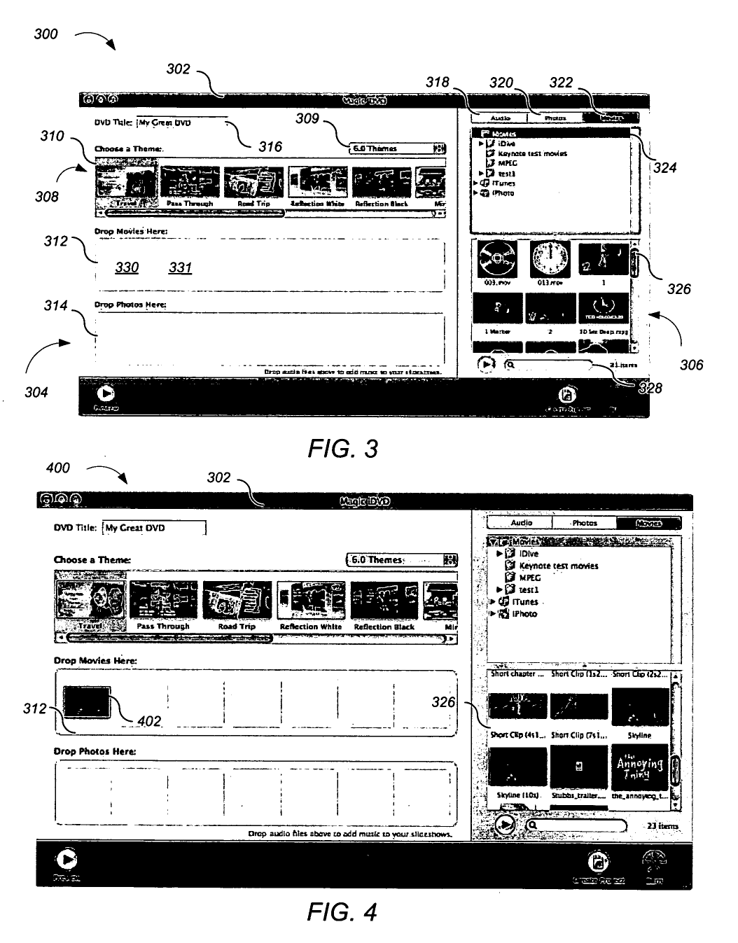

The UI component 110 provides a user interface allowing the user to interact with the automated media authoring tool 100 to create a media project. For example, the UI component 110 can be implemented by a piece of code (e.g., java, objective C, etc.) for presenting a user interface on a display device (e.g., a computer monitor) that includes menus and graphics configured to receive user input. An example of a user interface provided by the UI component 110 is shown in FIG. 3. FIG. 3 illustrates a user interface 302 for creating a media project, including menus and other structures for selecting a theme and media content to include in the project.

In some implementations, the user input is a theme selected from a theme menu, as described with respect to FIG. 3. The user interface can also be configured to display various media content that can be selected by a user to be included in a particular media project (e.g., movies 105, slideshows 107, etc.). The selected content can be received, for example, from the video selection component 104 and the image selection component 106.

The themes component 102 includes one or more themes 103. Each theme 103 can include a set of menu screen templates for use by the project generator 108 to provide a consistent menu environment for a particular media project. For example, a “travel” theme can include a set of menu screens having a similar look and feel for presenting media content to the user. In one implementation, the themes component 102 can provide a representation of each theme to the user interface component 110 for selection by the user.

A theme, as discussed above, can also be referred to as a theme family. A theme family is a set of menu screen templates having a similar style or look and feel. Thus, selection of a theme family includes a family of menu screens each having a similar style but designed for different content. For example, a theme family can include theme template menu screens for a main or root menu (i.e., a menu at the top of a menu hierarchy) as well as various submenus used in a media project such as a movies submenu, a slideshows submenu, and a chapter index submenu. Theme families can be pre-defined and included with the automated media authoring tool 100 or can alternatively be generated by the user. In some implementations, themes can be separate software components that can be authored by a third party for use with an automated media authoring tool 100.

Each template menu screen in a theme (or theme family) includes a theme definition. The theme definition defines the layout and behavior of menu screen elements or objects. For example, the theme definition can define a screen element and its properties, such as a location for menu screen content, buttons, background graphics, animation, text regions, drop zones.

One example of a theme element is a drop zone. Drop zones are regions defined by the theme definition and positioned within the menu screen environment. Drop zone properties can include position, size, orientation, transparency, and depth. Drop zones can be static or animated. Animated drop zones change over time and can follow a motion path, including rotational and translational movement, are described in U.S. Patent Application No. ______, entitled “Controlling Behavior of Elements In A Display Environment,” Attorney Docket No. 18814-020001. Drop zones can be configured to contain media content. For example, a user can drop an image or a film clip in a drop zone. When the drop zone is viewed in a menu environment, the image is displayed in the drop zone. If multiple images are placed in the drop zone, then a slide show can be played. If a video clip is placed in the drop zone, then the video clip can play for a predetermined amount of time (e.g., 10 secs) before starting over, i.e., or looping. In one implementation, the user can customize the duration of the video clip played in the drop zone, for example using a pop-up slider bar.

The theme definition can also include references to one or more patch files. In one implementation, a patch file is provided for each element or object defined by the theme definition. The patch file includes or invokes a rendering component to render the object. For example, a patch file can include data and methods for rendering the element associated with the patch file using known object oriented programming techniques and known OOP languages (e.g., C++, Java, etc.). In one implementation, the rendering component, after determining methods required by the element from the received patch file, can call one or more plug-in programs to perform the specified function. The rendering component can use the patch files and plug-ins to render the completed menu screens.

Theme definitions, drop zones and patch files, are discussed in co-pending U.S. patent application Ser. No. 10/337,924, filed on Jan. 6, 2003, and Ser. No. 10/742,957, filed on Dec. 22, 2003.

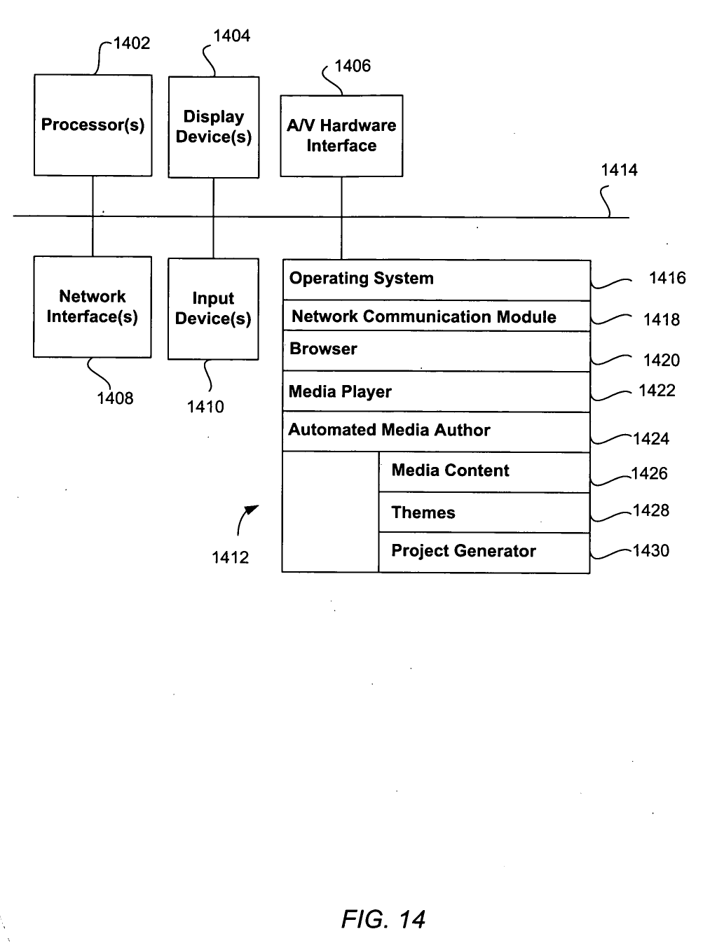

The video selection component 104 can be configured to retrieve one or more movies 105 for inclusion in a media project. The video selection component 104 can retrieve the movies 105 from one or more local or distributed storage devices. For example, movies 105 can be stored locally in a storage device of a personal computer providing the automated media authoring tool 100, as described with respect to FIG. 14. Alternatively, the movies 105 can be stored on a storage device accessible through a network connection (e.g., Internet, Ethernet, wireless LAN, etc.). The video selection component 104 provides user-selected movies to the project generator 108 for incorporation into media projects. The movies 105 can be composed of a single video clip or multiple chapters. A typical movie 105 includes identifiable chapter breaks encoded within the movie 105. Alternatively, the project generator 108 can automatically create chapter breaks for one or more movies 105. The chapter breaks can be used to automatically create a chapter index submenu screen (see FIG. 13 below for an example chapter index menu screen)

The image selection component 106 can also be configured to retrieve one or more slideshows 107 from local or distributed storage devices for inclusion in the media project. The image selection component 106 provides user-selected slideshows 107 to the project generator 108 for incorporation into media projects.

In some implementations, the project generator 108 creates menu screens for a media project corresponding to the theme and content selected by the user through the UI's of the media authoring tool 100. The project generator 108 can automatically create a set of menu screens incorporating user-identified content to generate a media project. The project generator 108 can select one or more template menu screens belonging to a selected theme 103. The particular menu screen templates of the theme are selected according to the corresponding user selected content. The project generator 108 can then populate the template menu screens with appropriate content, buttons, labels, and titles according to the media content selected by the user. The user can use the generated media project to complete the media authoring process, for example, by burning a DVD or other media that includes the automatically created menu screens and the associated media content. An individual can then access the menu screens in order to navigate and view the media content associated with the menu screens.

### Operation

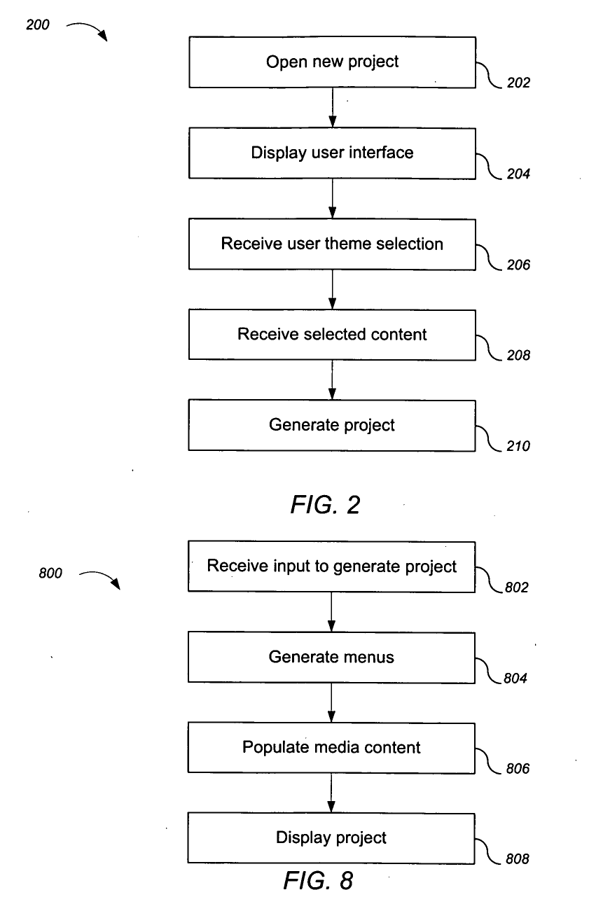

FIG. 2 shows a process 200 for defining a new media project. In some implementations, defining a media project includes selecting a theme and media content for the media project. The steps of process 200 do not have to occur in a specific order and at least some steps can occur simultaneously in a multithreading or multiprocessing environment.

Process 200 beings with receiving a user input to open a new media project (step 202). A user interface is presented to the user (step 204). The user interface provides configurable menus and fields for allowing the user to define the media project.

The user can provide text for a project title in the user interface. The project title can be incorporated into the created menu screens. For example, in creating a DVD, the project title corresponds to the title that will appear on the menu screen when the DVD is played.

The user can also select a theme for the project (step 206) from a theme menu or other selection mechanism. The themes provide a consistent look and feel for a project. Each theme can include a number of templates which can be used to automatically create a menu screen. The template menu screens provide a display environment that includes theme-related graphics and content selected by the user. Examples of themes include but are not limited to travel, birthdays, or any other pre-designed or user defined theme. In some implementations, the user interface can provide a list of themes, or a series of thumbnail images representing themes (e.g., an image of a theme-related graphic), or any other suitable mechanism for selecting a theme.

Content selections for the media project are received (step 208). The user can select various media content for inclusion in the media project. The user can select content of different media formats using menus in the user interface. For example, a movie menu can provide a list of available movies or movie clips and a slideshow menu can provide a list of available slideshows for inclusion in the media project. Other menus can present other types of media content for user selection. For example, an audio menu can present audio content that can be selected by the user for the media project. For example, the audio content can be music for the menu screens or for accompanying a selected slideshow when presented.

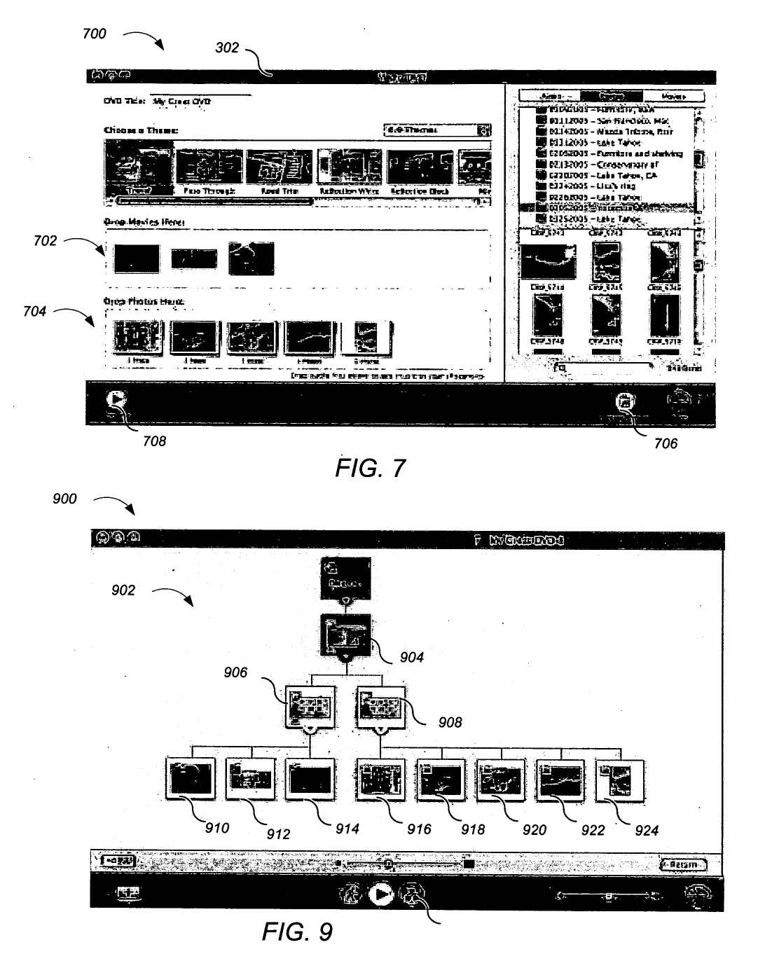

After the user has completed selection of the media content to include in the media project, the user can create (i.e., render) the media project to a file (step 210). For example, the user can select a “create” button in the user interface in order to generate a media project according to the user selections, as described with respect to FIG. 7. Alternatively, the user can select a “preview” button 708 to preview the menu screens prior to creating the project.

FIGS. 3-7 show screenshots illustrating a user interface for defining a media project. FIG. 3 shows a screenshot 300 of a user interface for creating a media project. The screenshot 300 includes a user interface 302. The user interface 302 includes an editing pane 304 and a content pane 306.

The editing pane 304 includes a number of fields, menus, and content placeholders for defining the media project. For example, the editing pane 304 includes a thumbnail display area 308. The thumbnail display area 308 presents a number of different themes to the user for selection. In the user interface 302 shown in FIG. 3, the thumbnail display area 308 includes a thumbnail image associated with each theme. In particular, FIG. 3 shows that the user selected the travel theme 310, which is shown as highlighted to indicate its selection. Different groups of themes can be shown in the thumbnail display area 308. For example, the user can select a particular group of themes using a theme group selection menu 309.

The editing pane 304 also includes drop regions 312 and 314 for adding movie and images to the media project, respectively. The drop regions 312 and 314 are configured to receive user selections of media content to be included in the media project. For example, the drop regions 312 and 314 can be configured to receive media content by dragging thumbnails representing content from the thumbnail display area 308 to the drop regions 312 and 314. The drop regions 312 and 314 can each include a number of ordered content placeholders (e.g., a first placeholder 330 and a second placeholder 331 in drop region 312). Thus, a first media content dropped in the drop region is positioned in the first placeholder 330 and a second media content in the second placeholder 331. In some implementations, the placeholder position can be used to determine a rank of importance of the selected content during the menu creation process.

In one implementation, the editing pane 304 can also include a title field 316. The user can provide a title identifying the media project by inputting text in the title field 316. The title can be imported into the created menu screens, for example by providing the title on the main menu screen.

The content pane 306 includes a number of menus for selecting media content for inclusion in the media project. The user interface 302 includes a navigation bar having three buttons for sorting content by media type, including an audio button 318, a photos button 320, and a movies button 322. The content pane 306 also includes a content viewer 324 showing a file structure hierarchy of available media content, which can be sorted to present particular media types. For example, the user can select movies from the file structure in the content viewer 324, which includes folders that can expand to present additional folders or files containing movies that can be selected.

The content pane 306 further includes a preview window 326 providing a list of content corresponding to the user selected folder from the content viewer 324. The preview window 326 can show a thumbnail of media content corresponding to the selected content type. For example, as shown in FIG. 3, the “movies” icon is selected in content viewer 324. The preview window 326, therefore presents the available movies for selection as a thumbnail image representing each movie. The thumbnails can be, for example, a single frame randomly selected from each respective movie. In another implementation, the thumbnail can be a particular designated frame. For example, a frame can be chosen from a particular time point within the movie (e.g., two seconds into the movie) to prevent the selection of a black frame at the beginning of the movie. Alternatively, the individual media content can be presented as a list. The content pane 306 can also include a search box 328. The search box 328 allows the user to search for particular media content stored on a local storage device or on a network device.

As discussed above, the user can select particular media content for inclusion in the media project. FIGS. 4-7 are screen shots illustrating user selection of media project content. FIG. 4 shows a screenshot 400 of the user interface 302 where a first movie 402 has been selected and positioned in the movie drop region 312. The first movie 402 can be selected, for example, by a drag and drop operation where the user selects the first movie 402 from the preview window 326 (e.g., using an input device such as a mouse) and drags the first movie 402 to a first content place holder position 330 in the drop region 312.

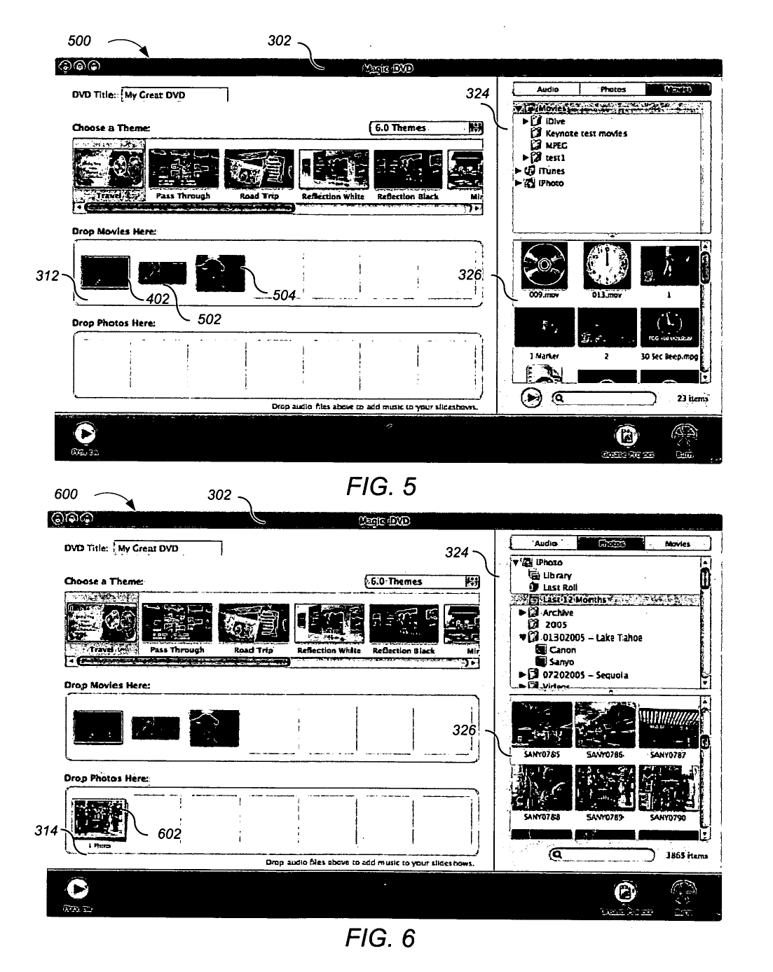

The user can select additional movies for inclusion in the media project. FIG. 5 shows a screenshot 500 of the user interface 302 where three movies 402, 502, and 504 have been selected and positioned in the drop region 312. Each of the three movies 402, 502, and 504, were selected from the preview window 326.

The user can also select other media content. FIG. 6 shows a screenshot 600 of the user interface 302 where the user has changed the content viewer 324 to display images in the preview window 326. The user has also selected a first slideshow 602 and positioned the slideshow in drop region 314. The first slideshow 602 can be selected, for example, by a drag and drop operation where the user selects the first slideshow 602 from the preview window 326 and drags the first slideshow 602 to a first content placeholder 330 in the drop region 312. Each selected slideshow can include one or more images. The number of images in a particular slideshow can be displayed under the dragged image in drop region 312.

The user can continue selecting until all of the desired content has been positioned in its respective drop regions 312 or 314. In FIG. 7, a screenshot 700 is shown including interface window 302. In FIG. 7, the user has selected three movies 702 and five slideshows 704. A user can also select other content, for example, the user can select audio files to accompany one or more menu screen presentations. Once the user has finished selecting content for the project, the user can create the project. For example, the user can select the “create project” button 706. Alternatively, the user can preview the project first by selecting the “preview” button 708. The preview button 708 can allow the user to view the menu screens in order to view the layout and content of the generated media project before rendering the presentation to a file, so that it can be burned to DVD or other media.

FIG. 8 shows a process 800 for automatically generating the media project such as defined in process 300 above.

The process 800 begins with receiving user input to generate the media project using the identified media content (step 802) (e.g., using the create project button 706 shown in FIG. 7). Menus screens are created for the media project (step 804). The menu screens can be created according to the menu screen templates for the selected theme of the media project.

The number of menu screens created is determined according to the particular media content selected when the user-defined content for inclusion in the media project. For example, if the user selected both movie content and slideshow content, the project generator (e.g., project generator 108) can create submenus for both the movie content and the slideshow content. Alternatively, if no slideshows were selected by the user, then no slideshow submenu would be generated. If one of the selected movies includes chapter markers, for example encoded chapter separations, a chapter index menu can be generated. Thus, the project generator can examine selected content to determine which menu screens to create.

After creating the necessary menu screens using the theme templates, the menu screens are populated with the particular user selected media content (step 806). For example, for each slideshow presented in the slideshow submenu, an image and name can be provided to represent each slideshow. In the finished media project (e.g., a DVD disc), the user can select a slideshow from the slideshow submenu (e.g., by selected the image button for the desired slideshow) in order to view the slideshow content.

The image representing the particular slideshow can be automatically selected from the images of the slideshow (if the slideshow contains more than one image). For example, the image used in the menu screen can be randomly selected from the images contained in the slideshow. Alternatively, the first image contained in the slideshow can automatically be selected. In one implementation, the name for the slideshow can be automatically extracted from the file, folder, or album name associated with the slideshow. Titles can also be manually entered by the user, left blank, or provided a default name (e.g., “My Slideshow”).

Similarly, the movies submenu can include images associated with each movie. A frame from the movie can be provided in a similar manner as the slideshow image to represent each movie available in the media project. Alternatively, a video clip can be provided from the target movie instead of a still frame. In one implementation, the video clip can continuously loop while presenting the submenu to the user.

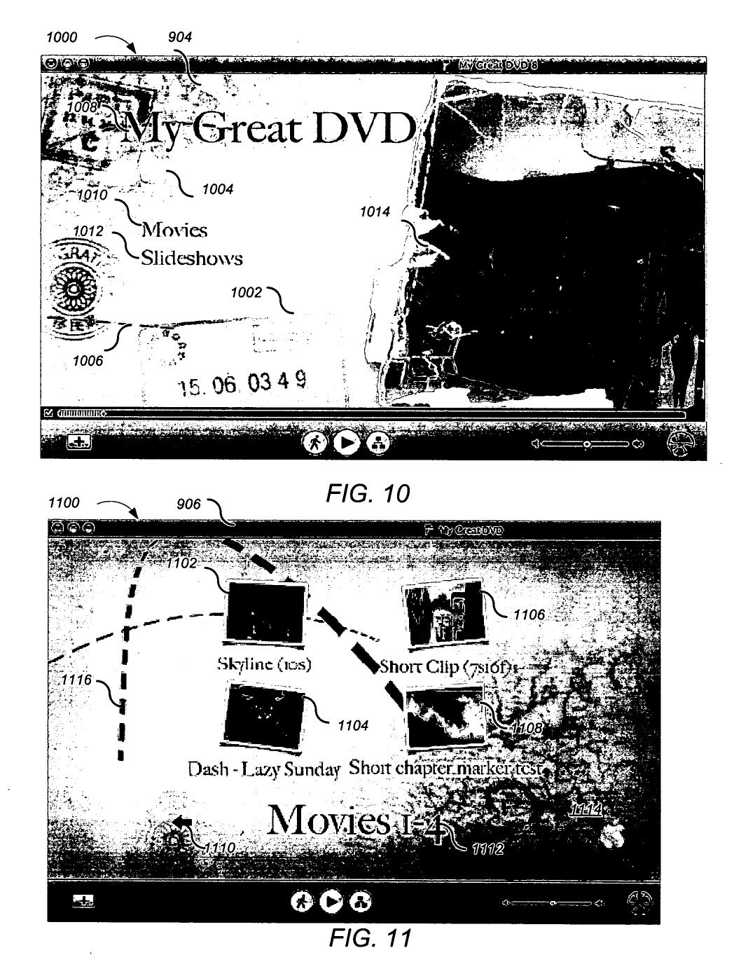

Other media content can also be populated in the generated menu screens depending on the structure of the provided theme as well as the selected content. For example, a particular menu screen template of a theme may also include regions for receiving user content in order to further customize the menu screens. For example, the main, or root, menu screen template can include one or more drop zones configured to receive user content (see, e.g., FIG. 10 below). These drop zones can be automatically populated with content from the user selected media. For example, an image from a slideshow or a clip from a movie can be automatically selected to be placed in a particular drop zone. Different media content can be automatically selected and positioned in each drop zone in the generated menu screens.

After populating the created menu screens, the completed media project is presented to the user (step 808). The user can edit the structure and automatically populated content to make changes according to the user's preference. For example, an authoring tool can be used to edit the created menu screens in order to refine the automatically generated media project. For example, the user can select a different image representing a particular slideshow than the one automatically selected (e.g., the user can change the slideshow image in the menu screen from the first image of the slideshow to the third image of the slideshow).

After the menu screens have been created and presented to the user, the user can finalize the media project. For example, the user can finalize the media project by rendering the project and all of the associated content into a DVD disc or other media. An individual can then view the menu screens and associated media content, for example by playing the DVD and using the created menus to select media content to view.

An example of the menu screens automatically created for the media content selected in FIG. 7 above, is shown in FIGS. 9-13. FIG. 9 shows a screenshot 900 of a map 902 illustrating the hierarchal structure of the automatically created menu screens in a media project. In some implementations, the map 902 includes a main menu screen 904. The main menu screen 904 is typically the initial menu screen presented to an individual playing the finished media project (e.g., the first menu screen shown after loading a DVD). The main menu screen 904 branches to two submenus: a movie submenu 906 and a slideshow submenu 908. The movie submenu 906 is linked to movies 910, 912, and 914, which were selected by the user when defining the media project (e.g., using process 200). The slideshow submenu 908 is linked to the media content of slideshows 916, 918, 920, 922, and 924.

All of the template menu screens associated with a selected theme are not necessarily used to generate the menu screens of the media project. The structure and number of menu screens depends on the particular content selected by the user. For example, if the user had initially selected only movie content, then slideshow submenu 908 would not be created nor appear in map 902. Additional menu screens can also be generated if needed. For example, if one of the movies is subdivided into chapters, a chapter index menu can be generated to allow the user to navigate to particular chapters of the movie.

FIG. 10 shows a screenshot 1000 of the main menu screen 904 of the generated media project. The main menu screen 904 is typically the first screen seen by a user executing the finished project such as by playing a DVD. The main menu screen 904 includes a background according to the selected theme. In the present example, a “travel” theme was selected. The background color and graphics provide an environment corresponding to the travel theme. For example, the background includes images of passport stamps 1002, an outline of a map 1004, and dashed lines 1006 travel paths.

The main menu screen 904 also includes the project title 1008 provided by the user. In some implementations, the user provided title is automatically positioned and formatted according to the theme definition. Thus, the user did not need to manually determine where to position or format the title in the menu screens.

The main menu screen 904 further includes buttons 1010 and 1012 for navigating to different content in the project. For the example of a DVD, the buttons 1010 and 1012 can be navigated to access and play content on the DVD. As shown in FIG. 10, buttons 1010 and 1012 provide links to the movies and slideshow submenus, respectively, of the media project. Again the user did not have to define the buttons of the main menu appropriate to the user selected content for the media project.

A drop zone 1014 is also included in the main menu screen 904. The drop zone 1014 includes an image from the user selected content. During the media project generation, content for the drop zone 1014 is automatically selected. For example, a random selection can be made from the selected content such as from the selected slideshows. Alternatively, the selection can be made based on other criteria. For example, the selection can be made from the slideshow positioned in the first position within the drop region 314 (FIG. 3), which can indicate the more important slideshow to the user. A movie clip can alternatively play within the drop zone 1014 from one of the selected movies. The move clip can loop continuously while the menu screen is presented.

FIG. 11 shows a screenshot 1100 of the movies submenu screen 906 of the generated project. The movies submenu screen 906 is the menu screen shown to a user who selected the movie button 1010 from main menu screen 904. The movies submenu screen 906 includes a background (e.g., a graphic, still image, or combination etc.) corresponding to the selected travel theme including travel path 1116 and map 1114. The movies submenu screen 906 includes one or more navigation buttons. Navigation arrow 1110, when selected, allows the user to return to the main menu screen 904.

The movies submenu screen 906 also includes a title 1112 (i.e., “Movies 1-4”). Each of the four movies shown provides a button through which a user can access the identified movie content. Each movie button includes an image 1102, 1104, 1106, and 1108 representing the movie. The images 1102-1108 are automatically selected from the movie represented by the image. For example, a frame from the movie can be selected to provide the button image. Alternatively, a clip from the target movie can also be used as the menu button. In one implementation, if a movie includes chapters for selection, a second button for accessing a chapter index menu can also be provided (see FIG. 13 below).

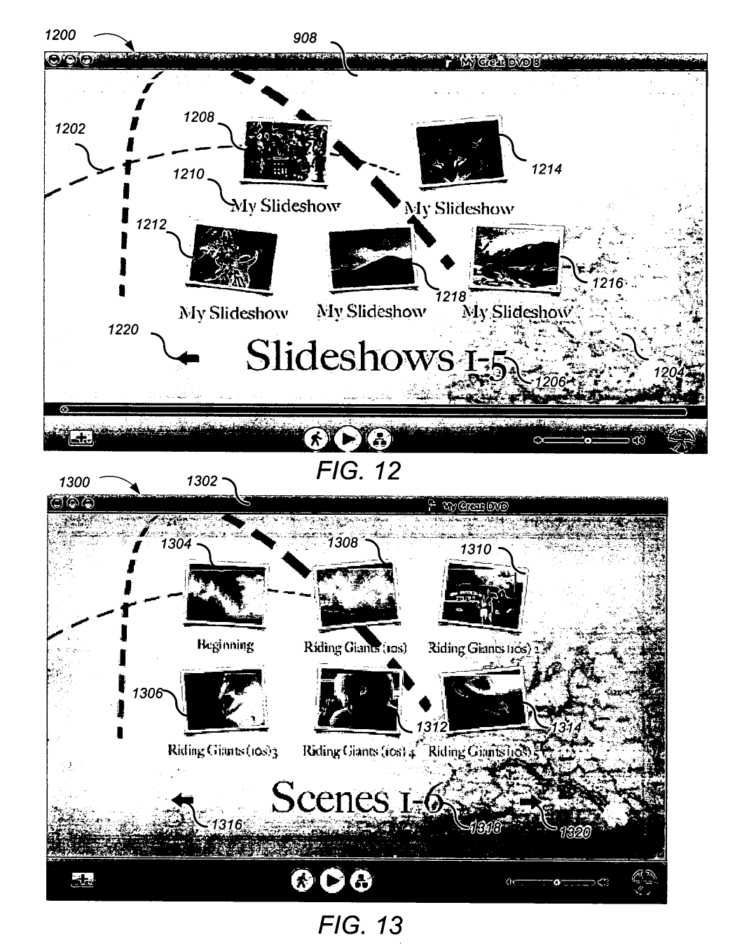

FIG. 12 shows a screenshot 1200 of the slideshow submenu screen 908 of the generated project. The slideshow submenu screen 908 is the menu screen shown to a user who selected the slideshow button 1012 from main menu screen 904. The slideshow submenu screen 908 also includes a background corresponding to the selected travel theme including flight paths 1202 and map 1204. The background shown in slideshow submenu screen 908 is the same as shown in movies submenu screen 906, however, different backgrounds can also be used. The slideshow submenu screen 908 also includes a title 1206 (i.e., “Slideshows 1-5”). In some implementations, the background can include animated objects that cannot be edited, but that are provided to add additional theme elements.

Each of the five slideshow buttons are represented in the slideshow submenu screen 908 by an image 1208 and a name 1210. Each image 1208 for each slideshow is automatically selected from the images within that particular slideshow. The slideshow submenu screen 908 also includes one or more navigation buttons. Navigation arrow 1220, when selected, allows the user to return to the main menu screen 904.

FIG. 13 shows a screenshot 1300 of a chapter index menu screen 1302. The chapter index menu screen 1302 can be provided, for example, when a particular movie includes encoded chapter markers. The chapter index menu screen 1302 provides for the selection of a particular scene in a particular movie. The chapter index menu 1302 includes a title 1318 (e.g., “Scenes 1-6”). The title can be used to indicate which chapters are shown. If the chapter index extends to several menu screens, navigation buttons can allow a user to navigate between menu screens. For example, navigation arrow 1320, when selected, can provide a second chapter index menu screen providing additional chapters (e.g., “Scenes 7-12”). Additional navigation buttons such as navigation arrow 1316 can allow the user to return to other menu screens, such as the movies submenu screen 906.

The chapter index menu screen includes a number of selection buttons 1304, 1306, 1308, 1310, 1312, and 1314. Each selection button 1304-1314, when selected, provides access to the particular chapter in the movie. Each button can include an image or movie clip automatically selected from the target chapter. The individual chapters can be identified by the project generator, for example, by identifying encoded chapter breaks present in the movie. In another implementation, the project generator can automatically create chapter breaks in a movie. Chapter markers are described in co-pending U.S. patent application Ser. No. 10/337,907, entitled “Method and Apparatus for Producing a Packaged Presentation,” filed on Jan. 6, 2003.

FIG. 14 is a block diagram of an exemplary user system architecture 1400 capable of hosting a media authoring tool that can electronically receive and manage access to digital media items. The architecture 1400 includes one or more processors 1402 (e.g., IBM PowerPC, Intel Pentium 4, etc.), one or more display devices 1404 (e.g., CRT, LCD), graphics processing units 1406 (e.g., NVIDIA GeForce, etc.), a network interface 1408 (e.g., Ethernet, FireWire, USB, etc.), input devices 1410 (e.g., keyboard, mouse, etc.), and one or more computer-readable mediums 1412. These components exchange communications and data via one or more buses 1414 (e.g., EISA, PCI, PCI Express, etc.).

The term “computer-readable medium” refers to any medium that participates in providing instructions to a processor 1402 for execution, including without limitation, non-volatile media (e.g., optical or magnetic disks), volatile media (e.g., SDRAM, ROM, Flash, etc.) and transmission media. Transmission media includes, without limitation, coaxial cables, copper wire and fiber optics. Transmission media can also take the form of acoustic, light or radio frequency waves.

The computer-readable medium 1412 further includes an operating system 1416 (e.g., Mac OS®, Windows®, Linux, etc.), a network communication module 1418, a browser 1420 (e.g., Safari®, Microsoft® Internet Explorer, Netscape®, etc.), a media player 1422 and an automated media authoring tool 1424.

The operating system 1416 can be multi-user, multiprocessing, multitasking, multithreading, real-time and the like. The operating system 1416 performs basic tasks, including but not limited to: recognizing input from input devices 1410; sending output to display devices 1404; keeping track of files and directories on computer-readable mediums 1412 (e.g., memory or a storage device); controlling peripheral devices (e.g., disk drives, printers, etc.); and managing traffic on the one or more buses 1414. The network communications module 1418 includes various components for establishing and maintaining network connections (e.g., software for implementing communication protocols, such as TCP/IP, HTTP, Ethernet, etc.). The browser 1420 enables the user to search a network (e.g., Internet) for information (e.g., digital media items). The media player 1422 (e.g., Quick Time®, Windows Media Player®, Real Player®, etc.) enables the user to view various media content (e.g., a movie file).

The automated media authoring tool 1424 provides various software components for performing the various functions for defining and generating a media project, as described with respect to FIGS. 1-13. The automated media authoring tool 1424 includes media content 1426, themes 1428, and a project generator 1430. The media content 1426 includes digital media including movies, images, audio and other digital media available for incorporation in a media project. The themes 1428 include theme definitions providing template menu screens for generating media projects. The project generator 1430 includes software components for receiving user selected themes and media content for a particular media project as described in FIG. 2 and for generating a media project using the user selected data as described in FIG. 8.

Particular embodiments of the invention have been described. Other embodiments are within the scope of the following claims. For example, the actions recited in the claims can be performed in a different order and still achieve desirable results. The method of defining a media project in FIG. 2 includes steps which can be performed in different order. For example, the media content can be selected before a theme is selected. In another implementation, the automated menu screen generation can be provided by one or more scripts within a larger authoring tool. For example, the automation process can be incorporated (e.g., using AppleScript) into a large scale and cross-application multimedia tool.

What is claimed is:

1. A computer program product, encoded on a computer-readable medium, operable to cause a data processing apparatus to perform operations, comprising:
generating a user interface for receiving user input, including:
a media content selection menu for selecting media content for a multimedia project; and
one or more regions for ordering selected media content for the multimedia project; and
automatically creating one or more menu screens according to the selected media content.

2. The computer program product of claim 1, further comprising:
receiving user input selecting media content from the media selection menu; and
receiving user input positioning the selected media content in a region of the one or more regions.

3. The computer program product of claim 2, wherein receiving user input selecting media content includes receiving a selection of movie content.

4. The computer program product of claim 2, wherein receiving a user input selecting media content includes receiving a selection of one or more still images.

5. The computer program product of claim 1, the automatically creating one or more menu screens further comprising:
using the selected media content to define a menu screen hierarchy corresponding to the selected media content.

6. The computer program product of claim 1, the automatically creating one or more menu screens further comprising:
populating a menu screen with the selected media content.

7. The computer program product of claim 1, the user interface further comprising:
a theme selection menu configured to receive user input selecting a theme for the one or more automatically created menu screens.

8. A computer-implemented method, comprising:
receiving a first user input selecting media content to be included in a media project; and
automatically creating one or more menu screens for navigating the selected media content in the media project, wherein a number and content of the one or more menu screens are defined according to the user selected media content.

9. The computer-implemented method of claim 8, further comprising:
receiving a second user input selecting a theme for the media project, where the theme defines a template structure for the one or more menu screens.

10. The computer-implemented method of claim 8, further comprising:
receiving a third user input defining a title for the media project.

11. The computer-implemented method of claim 8, where receiving the first user input selecting media content further comprises:
receiving a selection of one or more movies for inclusion in the media project.

12. The computer-implemented method of claim 8, where receiving the first user input selecting media content further comprises:
receiving a selection of one or more slideshows for inclusion in the media project.

13. The computer-implemented method of claim 8, where automatically creating one or more menu screens further comprises:
creating a main menu screen including selection buttons for different types of media content selected by the user.

14. The computer-implemented method of claim 8, where automatically creating one or more menu screens further comprises:
creating one or more submenu screens according to the types of media content selected by the user.

15. The computer-implemented method of claim 8, where automatically creating one or more menu screens further comprises:
extracting content from the selected content to provide representations of the particular content in the menu screens.

16. The computer-implemented method of claim 15, where the extracted content is an image from a slideshow.

17. The computer-implemented method of claim 15, where the extracted content is a frame from a movie.

18. The computer-implemented method of claim 15, where the extracted content is a clip from a movie.

19. The computer-implemented method of claim 15, where the extracted content is randomly selected from the user selected media content.

20. A computer program product, encoded on a computer-readable medium, operable to cause data processing apparatus to perform operations comprising:
receiving a first user input selecting media content to be included in a media project; and
automatically creating one or more menu screens for navigating the selected media content in the media project, a number and content of the one or more menu screens defined according to the user selected media content.
